(19) United States
(12) Patent Application Publication
(10) Pub. No.: US 2005/0181284 A1
(43) Pub. Date: Aug. 18, 2005

(54) Energy storage devices

(76) Inventor: Barry Culpin, Lancashire (GB)

Correspondence Address: MYERS BIGEL SIBLEY & SAJOVEC, PO BOX 37428, RALEIGH, NC, 27627, US

(21) Appl. No.: 10/499,470

(22) PCT Filed: Dec. 23, 2002
(86) PCT No.: PCT/GB02/05862

(30) Foreign Application Priority Data
Dec. 29, 2001 (GB) 0131091.1

(51) Int. Cl. H01M 2/16; H01M 10/10

(52) U.S. Cl. 429/247; 429/252; 29/623.1; 429/302

(57) ABSTRACT

FIG. (1) shows a battery generally designated (1), which is a lead-acid battery. The battery (1) includes the components normally found in a GMF (glass microfibre) battery. The battery (1) includes a container or box (2) of tough flame retardant material and positive plates or electrodes (3) comprising lead alloy grids covered with an active material of lead dioxide. In one embodiment of the battery (1), acid gelling material such as silica or the like (for example fumed silica or sodium silicate) is introduced into each GMF separator (5), preferably, during the manufacture of the separator itself. In a second embodiment, a gel is made up outside the separator container, for example, by mixing sodium silicate solution (water glass) and sulphuric acid and the battery is filled with the gel, thus allowing a gel to develop generally uniformly throughout the container and battery.

This invention relates to improvements in or relating to energy storage devices and is more particularly concerned with a battery.

Batteries have been known for many years and lead-acid batteries account for about 60% of all batteries sold worldwide. Lead-acid batteries tend to be more economical and have a high tolerance for abuse. Conventionally, lead-acid batteries are made by assembling one or more positive and negative plates in a container or cell which is filled with electrolyte in the form of dilute sulphuric acid. The or each positive plate is made from a lead alloy grid covered with an active material of lead dioxide and the or each negative plate is of spongy lead. The or each positive plate is connected to a first terminal post and the or each negative plate is connected to a second terminal post. Positive and negative plates are electrically isolated from each other by providing a sheet of microporous plastics or similar material (known as a separator) between them, which separator will allow acid to move between the plates through the micropores. Such batteries tend to have certain advantages and disadvantages which are well known. The batteries are usually strong and sturdy and thus may be used for starting, lighting and ignition on automotive vehicles or for electrical grid backup systems. The separators themselves are strong and easily manufactured. However, such batteries may be of a “flooded design” (i.e. the electrolyte saturates or covers the plates) and the battery requires to be topped up with electrolyte (water or sulphuric acid) periodically for maintenance and thus electrolyte material may be liable to spill from the battery, which tends to be disadvantageous for obvious reasons. In the flooded design, during charging, acid is liberated from the active material and since it is of a higher density than the surrounding liquid it falls to the bottom of the battery thereby reducing the capacity of the battery and adversely affecting the cycle life. This stratification of the electrolyte does not usually occur if the charging voltage is high enough as high voltages result in gassing at the electrodes and the gas production tends to act as a stirring mechanism to at least greatly reduce stratification. Such flooded batteries are not oxygen recombining and vent flammable gases on overcharge, which also tends to be disadvantageous. Even so, the hydrogen and oxygen produced with the gassing charge results in water loss, so, eventually, the battery will need to be topped up with liquid. It should also be noted that, as a result of temperature differences, convection currents can be set up in flooded batteries that aids electrolyte mixing tending to reduce stratification.

An alternative lead-acid battery design (for use in other applications such as in burglar alarms or other “clean” environments) is a sealed cell which uses a gelled electrolyte rather than a liquid acid electrolyte (i.e. dilute sulphuric acid). The gelled electrolyte consists of a mix of sulphuric acid and silica which produces a gel similar in consistency to a jelly. Such a design has the obvious advantage that the cell can be sealed and thus the electrolyte is a non-spill product. The design of this battery is similar to the flooded battery design except that a gelled electrolyte is used rather than a liquid electrolyte. It is possible to provide a battery which is sealed because oxygen recombination occurs in the battery. During use, water is lost from the gel that causes microcracks to develop (i.e. gassing off of the electrolyte occurs). In order to allow this gas to escape from the battery to atmosphere one or more one-way vents or valves are provided. The microcracks allow oxygen transport from positive to negative plates and substantially stops water loss when the battery is on float charge. Oxygen reaching the negative plate or plates is reduced to water so that further water loss is eliminated and the battery will be largely maintenance free. Additionally, the gelled lead-acid battery tends to be advantageous because stratification of the electrolyte is reduced and hence the cycle life is increased. Where the electrolyte is gelled the acid is absorbed by the gel when the acid is liberated, rather than falling to the bottom of the battery, thus, advantageously reducing stratification. However, gelled lead-acid batteries tend to be disadvantageous in certain respects. The internal resistance of the gelled battery is higher than a flooded battery so that the ability of the battery to deliver high currents is restricted. The electrical conductivity of the gel is not high because the microcracking of the gel leads to poor contact between the gel, the plates and the separators. Also, recombination of oxygen in the system is only efficient at low overcharge currents, which means recharging of the battery has to be carried out carefully in order that the battery is not damaged. Oxygen recombination is not 100% efficient but is typically about 90-99% based on the overcharge current.

A further lead-acid battery (GMF battery) design has become popular over the last ten years or so which utilises a liquid electrolyte in the form of dilute sulphuric acid but which employs a separator or separators of glass microfibers (GMF) having fibres of diameter of the order of 1 micron. In such GMF batteries the volume of electrolyte can be carefully monitored so that the separator or separators are not fully saturated thereby enabling oxygen transport through the separator and oxygen recombination to occur in a similar manner to that in a gelled lead-acid battery (except that oxygen recombination in the GMF battery tends to be more efficient). An advantage of the GMF battery over and above the flooded design is the provision of good oxygen recombination characteristics with a separator of very low resistance having good contact between positive and negative plates, since it is filled with liquid electrolyte. Even so, the separator or separators are not as efficient as the gelled battery in alleviating acid stratification so that the cycling performance of the GMF battery tends to be much poorer than the gelled design. The gelled lead-acid battery and the GMF battery are both known as a VRLA battery (valve regulated lead-acid) and cannot be topped up. Also, since the electrolyte in VRLA batteries is immobilised any gassing caused by overcharge does not produce mixing of the electrolyte as it does in a flooded battery.

Some comparative advantages and disadvantages of the GMF battery and gelled lead-acid battery are provided below:—

### GMF Battery

Advantages:—

1. A higher oxygen recombination so that water loss and hydrogen evolution is minimal,
2. Easy to intially fill the battery with acid,
3. Has a low internal resistance so that high currents can be drawn without voltage collapse
   Disadvantages
1. The glass microfibre separator is soft and more easily damaged leading to increased difficulty in handling,
2. The acid electrolyte has a tendency to stratify reducing capacity and adversely affecting cycle life.

### Gelled Design

Advantages:—

1. A low degree of stratification and hence good cycle life,
2. A strong separator that can be easily manufactured (it may be of microporous plastics material or similar as utilised in the flooded lead-acid battery).
   Disadvantages:—
1. The internal resistance is high so that the battery's ability to deliver high currents is restricted,
2. Oxygen transport is not as efficient as in the GMF design,
3. As a gelled electrolyte is required, acid and silica have to be mixed to form a gel that has to be added to the battery quickly before the gelling process starts and this requires strict production routines.

Accordingly, it is an object of the present invention to provide a battery or method of making same which is improved in at least some respect and/or to provide a battery or a method of making same in which one or more, of the aforementioned, or other, disadvantages are at least alleviated.

According to the present invention there is provided a battery having at least one positive plate or electrode and at least one negative plate or electrode separated from one another by a glass microfibre (GMF) separator or the like or by a separator having a porosity greater than about 60%, said battery including a gelled or at least partially gelled electrolyte.

The porosity of the separator may be up to 93% or 95% under no load or about 90% at standard pressure i.e. at 10 kpa. Generally, separator porosity is important because, e.g in a conventional VRLA GMF battery, the lower the porosity the lower the amount of electrolyte that can be used and the lower the capacity of the battery.

The Applicant has found that a battery design including a GMF separator and a gelled electrolyte appears to have advantages of both the GMF battery and the gelled lead-acid battery, seemingly without incurring additional disadvantages.

Usually, the battery will be a lead-acid battery and also it is envisaged that the positive plate will usually be made from a lead alloy (or lead, preferably pure) containing an active material of e.g. lead dioxide and the negative plate from a lead alloy (or lead, preferably pure) containing an active material of e.g. spongy lead, with a gelled electrolyte usually being made from sulphuric acid preferably mixed with silica (or like gelling agent). The plates will usually be in the form of a grid covered by active material.

Preferably, the or each separator is compressed between associated positive and negative plates. Where the porosity of the separator is about 93% or 95% under no load the thickness of the separator may be measured at 10 kpa which reduces thickness and porosity to about 90%. In the battery, the separator is preferably compressed between associated plates further by about 20-30% reducing porosity to about 85 or 87%. It is believed that the cycling properties of the battery will be enhanced because of the compression of the separator onto the plates since compressed designs are known to give a good cycle life. It is believed that better electrical contact is maintained where the separator is under compression and better overall performance of the battery may be maintained.

The separator may include microfibres of a material other than glass such as polyester. A mixture of glass microfibres and polyester microfibres will produce a separator which is stronger than a separator made exclusively of glass microfibres. A separator may conveniently be provided of about 92% glass microfibres and about 8% polyester microfibres. Such a mixture eases the production process for the separator. Polyester microfibres may be of thickness about 0.5-2.0 microns.

It is envisaged that the battery in accordance with the present invention will normally be a sealed battery since it should have oxygen recombination characteristics.

In one embodiment of the present invention, it is envisaged that the battery will include a limited amount of liquid electrolyte with a gelled electrolyte being provided in the separator or separators.

In an alternative embodiment, it is envisaged that the battery will be substantially filled with the gelled electrolyte. It is envisaged that the electrolyte volume will usually be less than the pore volume of the plates and separator/s so that the separator/s is/are not fully saturated i.e. gas channels will be maintained in the separator/s to allow oxygen transport.

Further according to the present invention there is provided a method of making a battery, said method comprising introducing at least one positive plate or electrode and at least one negative plate or electrode into a container, introducing a glass microporous fibre or similar material separator or a separator having greater than about 60% porosity in between associated positive and negative plates and introducing or forming a gelled or at least partially gelled electrolyte in the container.

Advantageously, the porosity of the separator may be up to about 93-95%.

Preferably, the separator is compressed between the associated plates. When porosity of the separator is 93-95% it may be reduced to about 85% upon compression.

In one embodiment of the method, a limited amount of liquid electrolyte is introduced into the container and a gelling agent such as silica is introduced into the or each separator prior to insertion into the electrolyte in the container. In this way, the liquid electrolyte at least in the separator will become gelled yielding the advantage of reduced stratification of the electrolyte over and above flooded lead-acid batteries.

Alternatively, the battery container may be substantially filled (filled to excess) with gelled electrolyte which may advantageously provide a battery having the cycle life of a gelled lead-acid battery but with good oxygen recombination characteristics of a GMF battery by achieving oxygen transport through microcracks formed along the surface of the separator rather than relying on the drying out and cracking of the gel that occurs in a conventional gelled lead-acid battery. Alternatively, the battery container may contain only a limited amount of gelled electrolyte rather than being filled to excess.

Further advantages of the present invention will be apparent from the following description and drawings.

Embodiments of a battery and methods of making same, will now be described, by way of example only, with reference to the accompanying much simplified drawings in which:

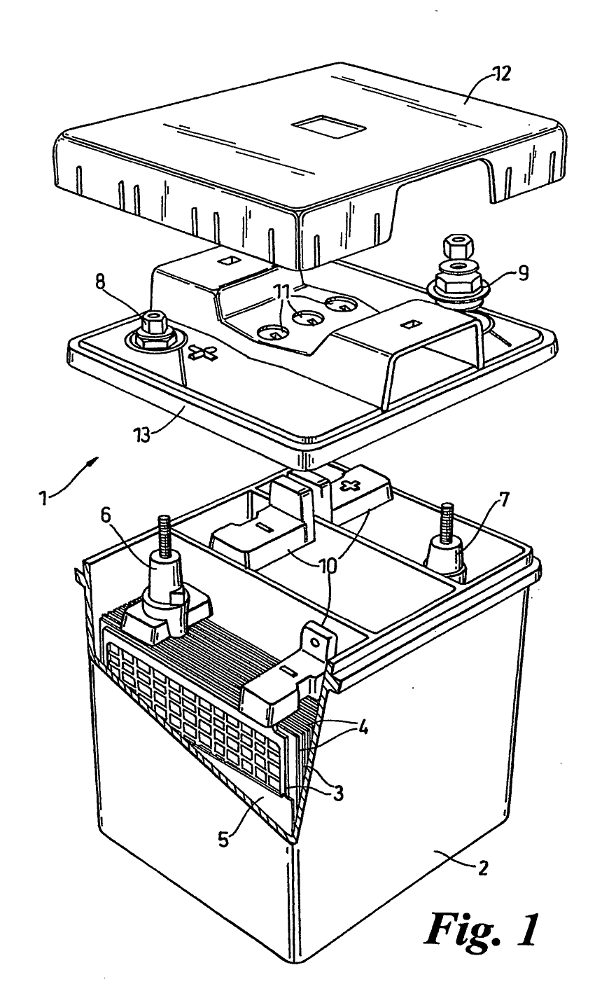

FIG. 1 shows an exploded perspective view of the first embodiment of a battery in accordance with the present invention;

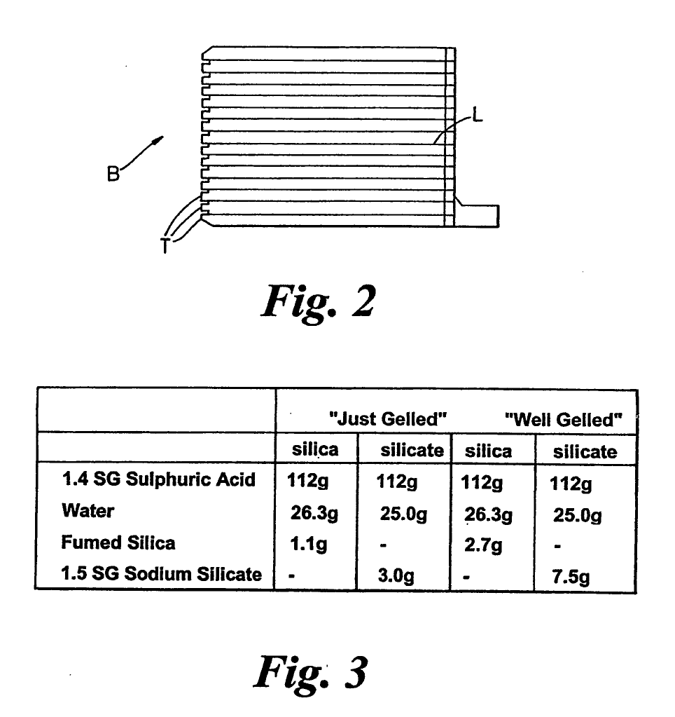

FIG. 2 shows a tubular design positive plate or electrode for use in a tubular cell design battery according to a further embodiment of a battery in accordance with the present invention and,

FIG. 3 shows a results table showing comparative values of silica and silicates for “just gelled” and “well gelled” electrolyte compositions suitable for batteries in accordance with the present invention.

FIG. 1 shows a battery generally designated 1, which is a lead-acid battery. The battery 1 includes the components normally found in a GMF (glass microfibre) battery. The battery 1 includes a container or box 2 of tough flame retardant material such as thick-wall VO rated ABS plastics which is highly resistant to shock and vibration. Positive plates or electrodes 3 comprise lead alloy grids covered with an active material of lead dioxide. The active materials may be made in a conventional manner by pasting the grids with a paste of lead monoxide, water and sulphuric acid. After curing and drying the plates 3 are formed by locating them in a tank of dilute sulphuric acid and passing a DC current through the plates until all the dried paste is converted to active material. The positive plates 3 are thick (for example 3.85 mm) compared with the negative plates 4 which are of spongy lead material (for example 2.45 mm thick). The plates 3,4 are arranged alternatively in the battery container 2 as shown with GMF separators 5 being located under compression in between respective pairs of associated positive and negative plates 3,4. In the example as shown, the plates 3,4 are spaced apart by 1.7 mm and a total of eleven plates are used, five positive plates 3 and six negative plates 4. However, it is to be appreciated that any combination and number of positive and negative plates 3,4 may be used spaced apart by appropriate distances to suit the separators 5 employed. In the example as shown in FIG. 1 each plate 3,4 is of a size 146×147 mm. The positive plates 3 are connected to a high conductivity terminal pillar 6 with threaded brass insert for maximum conductivity and ease of installation. The negative plates 4 are connected to terminal pillar 7 also provided with a threaded brass insert. Terminal pillars 6 and 7 are connected to respective positive and negative battery terminals 8 and 9 as should be evident from the FIG. 1.

The battery 1 is provided with intercell connectors 10 designed to withstand ultra high currents. The battery is a VRLA battery (valve regulating lead-acid) and includes a low-pressure valve 11 (operates at 20 kpa) to prevent ingress of oxygen into battery from the atmosphere. The battery 1 is provided with an electrically insulating cover 12 of known design. Lid 13 is of flame retardant ABS plastics which is heat-seal welded to the container 2 in a known manner.

In a known battery, a liquid electrolyte (not shown) in the form of dilute sulphuric acid is introduced into the container 2 in a carefully monitored amount in which the separators 5 are not fully saturated. In this manner, oxygen transport is possible through the separators allowing oxygen recombination in a similar manner to a gelled cell.

In one embodiment of the battery 1 in accordance with present invention, an acid gelling material such as silica or the like (for example fumed silica or sodium silicate) is introduced into each GMF separator 5, preferably, during the manufacture of the separator itself. Thus, the battery 1 can be assembled as is normally done with a GMF battery except that there is now a gelling material in the separator such that when a limited volume of liquid acid electrolyte is introduced into the container 2 the gelling agent in the separators will cause at least the electrolyte material present between the positive and negative plates to gel. Thus, the battery 1 could be described as being partially or semi-gelled in that all the electrolyte material in the battery need not necessarily be converted into a gel but rather the gelling may largely be localised to within the regions of the separators 5.

In this manner, it is believed that the first described embodiment of a battery 1 in accordance with the present invention will have some of the advantages of both a GMF battery and a gelled lead-acid battery without incurring additional disadvantages. By providing a limited volume of acid electrolyte, the oxygen recombination characteristics of the battery should be maintained and also, by having at least some gelled electrolyte, stratification of the electrolyte should be minimised with a good cycle life being achieved. Cycling properties of the battery 1 should be enhanced where the separators 5 are compressed between the negative and positive plates yielding good electrical contact.

An important feature of the present invention is the selection of the separator material. Microporous plastics separators as used in flooded lead-acid batteries tend to have a porosity of about 55-60% whereas the porosity of the GMF separator selected may be much greater than this, for example 93%. Clearly, the porosity of a material varies under pressure and the standard test pressure for porosity is the porosity obtainable for a material under a pressure of 10 kpa. Thus, the material used for the GMF separator may be of the porosity of 93% or 95% but once placed under compression between positive and negative plates may be of porosity more in the order of 85%. Additionally, the GMF separator may include microfibres of other materials such as polyester (e.g. 8%) in order to increase strength and advantageously ease production methods.

It is to be noted that, typically, lead-acid batteries of the flooded type have been utilised in the automotive industry but gelled lead-acid batteries, owing to the disadvantages involved, have not generally been employed in such an application and have been for example utilised in burglar alarms; thus, the use of both battery technologies has not generally been compatible.

The Applicant has realised that a lead-acid battery can be produced using both a GMF separator or the like and at least some gelled electrolyte rather than a purely liquid electrolyte.

In a second embodiment of a battery in accordance with the present invention, the battery 1 includes GMF separators of the general type used in a GMF battery but gelling agent or silica is not introduced into the separators during manufacture. The GMF separators 5 (in either embodiment of a battery in accordance with the present invention) could be made up of glass microfibres of diameter 0.5-3.0 microns thick (for example 1 micron) made up into a sheet that may have a basis weight of about 325 gm⁻². The size of the separator may be 158×178 mm. In this second described embodiment rather than introducing a gelling agent into the separators to gel a liquid electrolyte at least in the region of the separator itself, a gel is made up outside the separator container, for example, by mixing sodium silicate solution (water glass) and sulphuric acid and using this to fill the battery, and thus allowing a gel to develop generally uniformly throughout the container. Thus, the battery 1 may be filled with excess gelled electrolyte. It is believed that the second embodiment of the battery 1 may not be as successful as the first described embodiment in which a gelling agent is introduced in the separators (usually prior to insertion in the container). Even so it is believed that the design will have a cycle life comparable with a gelled lead-acid battery design and still maintain some of the good oxygen recombination characteristics associated with a GMF battery (by achieving oxygen transport through micro cracks formed along the surface of the glass fibres of the separator rather than relying on the drying out and cracking of the gel as in the conventional gelled acid battery design). A third option is to add the acid and gelling agent in a limited amount in the battery container rather than filling to excess.

The Applicant is primarily concerned with the first embodiment of the invention in which gelling agent is introduced into the separators during manufacture. Importantly and advantageously, the separator may consist of a simple single layer construction. Preferably, the gelling agent (silica) is added to the glass fibres as a dilute aqueous slurry and pumped onto the wire of a paper making machine in one application or layer as with a conventional GMF material. Thus, there is a homogeneous mix of the constituents throughout the thickness of the separator. The fibres themselves may consist of coarse and fine fibres randomly distributed within the layer. Thus, no specialist equipment or additional time or processes are required to produce the separator incorporating the gelling agent.

Known VRLA batteries filled with ungelled electrolyte obtain immediate oxygen transport between the plates to achieve 95% recombination and a gassing rate of virtually zero. This is obtained by having less than 100% electrolyte saturation, a separator with a relatively large pore size (at least 10 microns and preferably greater than 16 microns) and an intimate contact between the separator and associated positive and negative plates. Intimate contact is achieved by compressing the separator between the plates to about 60-85% of the original thickness.

The first embodiment of this invention is concerned with a VRLA battery which may achieve substantially the same recombination and gassing rates as known VRLA batteries but with an at least partially gelled electrolyte. To achieve this result, battery construction and processing is substantially similar to that of a non-gelled VRLA battery except that non-gelled or liquid electrolyte is introduced into the battery container to achieve a less than 100% electrolyte saturation and the separator/s contains a gelling agent. A relatively large pore size (e,g, greater than 16 microns) may be obtained by using a mix of fine and coarse fibres in a single layer construction of the separator.

GB patent specification No. 2074 779 discloses a method of producing a gelled electrolyte for use with a glass fibre separator but does not envisage the use of a gelling agent (silica) being introduced into the separator during the manufacturing process. Example 3 of that specification involves the cells being filled with gel in the manner of a conventional gelled electrolyte system. In the first embodiment of the present invention it is important that the total electrolyte volume is less than the combined total volume porosity of the plates and separators to allow oxygen transport through the separator in the same manner as a standard VRLA cell operating with liquid electrolyte. Additionally, in such a scenario good contact between the plates and separator is necessary which is achievable through compression of the separator.

GB 2074779 discloses a cell with an initial gassing rate of 0.006 cu ft/Ah decreasing to zero over a month. This is typical behaviour of a conventional gelled cell; as the cell gasses and loses water the gel starts to dry out and produces cracks which allow gas transport. Advantageously, in the first embodiment of the present invention the porosity to yield oxygen transport is immediate and the gassing rate is zero even with a new battery. This is important since the user would not want hydrogen and oxygen evolution from the battery even for the first month or so since oxygen/hydrogen explosions can be very violent. Using the data provided in GB 2074 779 (see page 5 line 46 onwards of that specification), for example, for a gassing rate of 0.006 cu ft/Ah compared with 0.024 for the comparative standard cells a recombination rate of only 75% would seem possible whereas, advantageously, recombination rates of 95% are achievable by cells constructed in accordance with said first embodiment of the present invention.

In the first described embodiment of the battery 1, the liquid acid volume will not usually completely fill the pore volume of the plates and separators but will allow some residual porosity for gas transport typically being about 5% of the total pore volume. In this particular example, the acid filling volume may be 1030 cm³.

It is important in batteries in accordance with the present invention that acid and gelling agent (silica) are added in a calculated known quantity so that some gaseous porosity is retained in the separator/s to allow oxygen tansport. In this respect the battery in accordance with the present invention will function in a similar way to a conventional GMF battery and will not rely on rely on microcracks developing to achieve oxygen recombination. A major difference between battery designs in accordance with the present invention and conventional GMF designs as opposed to conventional gelled lead-acid batteries, is that oxygen recombination is high (about 95%) from the beginning of the life of the battery. However, with a conventional gelled battery oxygen recombination is low until microcracks are formed as aforesaid. Thus, it tends to be disadvantageous that during an initial period of use of the gelled battery, significant amounts of hydrogen will be generated and vented to atmosphere causing obvious hazards.

To summarise, conventional gelled lead-acid batteries have the characteristics of poor high rate performance and poor recombination efficiency but good cycle life performance. The good cycle life performance has shown to be as a result of low stratification of the acid on cycling.

In contrast, GMF batteries have a good high rate performance and good recombination, efficiency but generally poor cyclability, which can be attributed to a greater degree of stratification compared to gelled lead-acid batteries. One embodiment of the present invention envisages a battery with a GMF separator or the like and a measured amount of gelled electrolyte so that some porosity is maintained in the separator in order to give good oxygen recombination and to reduce stratification thereby yielding good cycle lives with short recharge times. The GMF separators should provide a low resistance more particularly when compared with a gelled lead-acid battery that uses a microporous polyethylene or plastics separator.

The Applicant has carried out tests on a battery in accordance with the first embodiment i.e. using GMF separators including silica. When tested up to BS 6290, part 4 the battery achieved the cycling performance as follows:
BS 6290 requirement>50 cycles
3VB11 standard product GMF battery 150-250 cycles
Battery in accordance with the first embodiment of the present invention with silica introduced into the separators 1000 cycles.

Thus, in testing a battery in accordance with the first embodiment of the present invention the cycle performance increased to about 4-6.66 times that of a standard GMF battery.

Additionally, the Applicant has tested a battery in accordance with the second embodiment of the present invention in which an electrolyte gel is introduced into the container of the battery after the separators (not including silica) have been introduced between the negative and positive plates and introduced into the container. The gel was made by mixing sodium silicate solution (water glass) and sulphuric acid and using this to fill the battery and then allowing the gel to the develop. The battery in accordance with the second embodiment of the present invention was tested over a cycling regime of 20 hours rate 100% discharges followed by recharge for 3 days at 2.27 volts per cell such that over a period of 10 cycles the capacity loss was 8%.

A similar test performed on a standard product GMF battery showed a capacity loss of 20%.

Importantly, the Applicant has realised that there may be advantages in utilising a GMF separator or the like with an electrolyte that is not entirely liquid. Thus the degree of gelling of electrolyte used and the location of the gel in the cell are both important factors in perfecting the general performance of the battery. If these factors can be closely controlled it is believed that an improved battery will result (see FIG. 3).

There are two basic routes to making a gel with sulphuric acid. One is to mix sulphuric acid, water and fumed silica; the other is to use sulphuric acid, water and sodium silicate. Both techniques result in the same gel. Fumed silica is a very high surface area small particle size solid that is dissolved in the acid to make the gel. The sodium silicate is supplied as a concentrated solution in water (commonly called water glass) and this solution is added to the acid Formulations vary as to the amount of gelling agent to use but well gelled/just gelled formulations used by the applicant are as shown in FIG. 3.

These formulations give a final acid specific gravity of 1.30 as required in the battery together with enough silica to either just gel or well gel the acid as required, using both fumed silica and sodium silicate as the starting materials.

The VRLA battery system eliminates water loss by allowing oxygen generated at the positive electrode on charge to diffuse through the separator to recombine on the negative electrode. This is achieved by ensuring that the amount of acid added to the cell is not sufficient to fully saturate the separator i.e. there remains some void volume to allow gas transport. The “well gelled” approach will give the cell the best resistance against stratification but because the acid is immobile it may completely block the pores in the separator and hence stop oxygen transport. Thus, it is believed the “just gelled” approach will increase the acid viscosity sufficiently to stop stratification but allow sufficient mobility to allow the oxygen to find a way through the separator to recombine on the negative electrode. Typical separators of the GMF type are 2.5 mm thick and the Applicant's battery designs should require typically about 31 grams per sq. metre of separator (31 g/m²) for the “just gelled” design and 78 grams per sq. metre of separator (78 g/m²) for the “well gelled” design.

FIG. 2 shows a typical plate or electrode for a tubular cell design battery in accordance with the third embodiment of the present invention.

The tubular cell design battery is traditionally a flooded design used for cycling applications such as forklift trucks and milk floats. The good cycle life is achieved by maintaining the positive active material in good contact with a central lead spine conductor using a woven or non-woven porous polymer tube. A typical plate will have 15 of these porous polymer tubes T as shown side by side in FIG. 2. Owing to the geometry of the tubular cell design it can be difficult to achieve good contact between the positive plates and the separator so a GMF battery design with oxygen recombination may be difficult to achieve. However, the third embodiment of the present invention envisages using a GMF separator or the like and substantially filling the battery with a gelled electrolyte (carefully monitored amount to retain some gaseous porosity in the separator) to achieve a good compromise giving very good cycling characteristics of tubular design with the gelled electrolyte filling voids between the positive plate and the separator giving some oxygen recombination. Good oxygen recombination should be achieved and good contact between tubes of the positive plate and separator. Normally, the good cycle life of the tubular cell design battery is achieved by maintaining the positive active material in good contact with the central lead spine conductor L using a woven or non-woven porous polymer tube.

It is to be appreciated that the present invention offers many improvements, at least some of which might be patentable individually or in combination. Any individual feature as aforementioned or as shown or implicit herein or combinations thereof, or functions or methods appertaining thereto, may be patentably inventive and any specific term as used herein should not be construed as unnecessarily or unduly limiting, the scope of such a term should extend to, or may be replaced or supplemented by, any equivalent or generic expression. For example, glass microfibre separator may be replaced by microporous separator. Additionally, any range mentioned herein for any parameter or variable shall be taken to include a disclosure of any derivable sub-range within that range or of any particular value of the variable or parameter arranged within, or at an end of, the range or sub-range.

Still further according to the present invention there is provided a battery having one or more of the following:—
1. An electrolyte comprising a mix of liquid and gel or a partially gelled electrolyte
2. A battery as in 1, in which the gel is concentrated around separators in between positive and negative electrodes or plates,
3. A GMF separator or separator of porosity greater than about 60% and a gelled or semi or part-gelled electrolyte,
4. A GMF separator or the like and a carefully controlled gelled electrolyte characteristic;
5. A GMF separator or the like and at least some just gelled electrolyte of about 31 g of gelling agent (e.g. silica) per m² of separator;
6. A GMF separator or the like and at least some well gelled electrolyte of about 78 g of gelling agent (e.g. silica) per m² of separator;
7. A GMF separator or the like and an electrolyte having at least a partially gelled electrolyte of about 31 to about 78 g of gelling agent (e.g. silica) per m² of separator;
8. An electrolyte made up of a ratio of gelling agent to acid of about 0.01:1 or 0.018:1 or 0.027:1 or 0.024:1 or 0.067:1 or 0.0455:1 or any ratio derivable form FIG. 3 of the accompanying drawings;
9. A separator having a pore size of at least 10 microns and preferably greater than 16 microns;
10. A separator of single layer construction preferably made up from coarse and fine fibres and gelling agent;
11. A separator compressed between positive and negative plates;
12. An electrolyte volume less than the pore volume of the plates and separator/s and
13. A tubular positive plate

The important controlled characteristic of the gelled electrolyte will usually be the viscosity and/or positioning of the gel.

The important factors governing battery designs in accordance with the present invention will be:—
1) The degree of gelling i.e. production of a gel having an acid viscosity controlled to substantially stop stratification without plugging up the porosity in the separator/s;
2) The position of the gel i.e. gelling of the acid in the separator/s to substantially stop stratification whilst maintaining the acid between the plates liquid to yield good electrical performance.

The phrase ‘partially gelled electrolyte’ as used throughout this specification means an electrolyte having a portion thereof which is gelled and another portion which is not and which may e.g. be liquid. The phrase ‘semi-gelled electrolyte’ as used throughout this specification means an electrolyte which is (substantially half-way) in between a liquid state and a gel state. It is possible the battery may contain well gelled electrolyte in the separators and just gelled electrolyte in the remainder of the battery. Thus, the consistency of gel used in the battery need not be uniform throughout. The ratio of gel to liquid may vary throughout the life of the battery.

Still further according to the present invention there is provided a VRLA battery having at least one positive plate or electrode and at least one negative plate or electrode separated from one another by a glass microfibre (GMF) separator or the like having a porosity greater than about 60%, the or each separator being in intimate contact with and compressed between associated positive and negative plates, said separator being of a single layer construction and including a gelling agent, said battery including at least partially gelled electrolyte in between said plates, the electrolyte volume being less than the pore volume of the plates and separator/s so that the separator/s is/are not fully saturated.

Still further according to the present invention there is provided a VRLA battery having at least one positive plate or electrode separated from one another by a microporous separator of single layer construction containing a gelling agent, the battery having an at least partially gelled electrolyte in between said plates.

Still further according to the present invention there is provided a VRLA battery (preferably GMF battery) having at least one positive plate or electrode separated from one another by a microporous separator, the battery having having just-gelled and/or well-gelled electrolyte.

Still further according to the present invention there is provided a microporous separator of single layer construction including a gelling agent for a battery (preferably a VRLA battery).

1. A VRLA battery having at least one positive plate or electrode and at least one negative plate or electrode separated from one another by a separator having a porosity greater than about 60%, the or each separator being in intimate contact with and compressed between associated positive and negative plates, said separator being of a single layer construction and including a gelling agent, said battery including at lest partially gelled electrolyte in between said plates, the electrolyte volume being less than the pore volume of the plates and separator/s so that the separator/s is/are not fully saturated.

2. A battery as claimed in claim 1 in which the porosity of the separator is up to 93% or 95% under no load or about 90% at standard pressure.

3. A battery as claimed in claim 1 in which the separator includes microfibres of a material other than glass such as polyester.

4. A battery as claimed in claim 1 in which the separator is provided with about 92% glass microfibres and about 8% polyester microfibres.

5. A battery as claimed in claim 1 having a limited amount of liquid electrolyte with a gelled electrolyte being provided in the separator.

6. A battery as claimed in claim 1 in which the separator has a pore size of 10 microns or greater.

7. A battery as claimed in claim 1 having about 95% oxygen recombination and/or a gassing rate near zero.

8. A method of making a VRLA battery, said method comprising introducing at least one positive plate or electrode and at least one negative plate or electrode into a container, forming a separator of glass microporous fibres and gelling agent in a single layer construction, introducing the separator having greater than about 60% porosity in intimate contact with associated positive and negative plates, and compressing the separator therebetween and forming an at least partially gelled electrolyte in the container in between said plates, the battery having an electrolyte volume less than the pore volume of the plates and separator/s.

9. A method as claimed in claim 8 in which the porosity of the separator is up to about 93-95%.

10. A method as claimed in of claim 1 in which a limited amount of liquid electrolyte is introduced into the container and a gelling agent is introduced into the or each separator prior to insertion into the container.

11. (canceled)

12. A VRLA battery having at least two positive plates or electrodes separated from one another by a microporous separator of single layer construction containing a gelling agent, the battery having an at least partially gelled electrolyte in between said plates.

13. A VRLA battery having at least two positive plates or electrodes separated from one another by a microporous separator, the battery having just-gelled and/or well-gelled electrolyte.
